(19) United States
(12) Patent Application Publication
(10) Pub. No.: US 2012/0081499 A1
(43) Pub. Date: Apr. 5, 2012

(54) PRINT HEAD AND IMAGE-FORMING APPARATUS

(75) Inventors: Takanori TSUNASHIMA, Ageo-shi (JP); Yoshiro Aoki, Saitama-shi (JP)

(73) Assignee: Toshiba Mobile Display Co., Ltd., Saitama (JP)

(21) Appl. No.: 13/185,383

(22) Filed: Jul. 18, 2011

(30) Foreign Application Priority Data
Sep. 30, 2010 (JP) 2010-222655

(51) Int. Cl. B41J 2/435

(52) U.S. Cl. 347/247

(57) ABSTRACT

According to one embodiment, a print head includes first and second substrates, an OLED array and a drive circuit. The first substrate extending in a first direction and has a main surface including first to third regions. The first region extends in the first direction. The second and third regions are arranged in a second direction crossing the first direction with the first region interposed between the second and third regions. The OLED array includes first electrodes arranged above the first region, an organic emitting layer positioned above the first electrodes, and a second electrode positioned above the organic emitting layer. The drive circuit is configured to supply drive currents to the first electrodes and includes a first circuit positioned above the third region and a second circuit positioned above the third region.

### CROSS-REFERENCE TO RELATED APPLICATIONS

This application is based upon and claims the benefit of priority from Japanese Patent Application No. 2010-222655, filed Sep. 30, 2010; the entire contents of which are incorporated herein by reference.

### FIELD

Embodiments described herein relate generally to a print head and an image-forming apparatus.

### BACKGROUND

Light-emitting diode (hereinafter referred to as LED) printers that include arrays of LEDs are under development. In the LED printers, the light source is placed near the photoconductor drum in contrast to the laser printers. Therefore, the LED printers can be formed to have smaller sizes than those of the laser printers.

The print head of an LED printer includes semiconductor chips each having LEDs formed thereon with high density. This print head has a structure in which such semiconductor chips are arranged with high accuracy of position. Therefore, for manufacturing the print heads of the LED printers, a sophisticated mounting technology and a high cost are necessary.

In this situation, attention is given to a print head including organic electroluminescence (hereinafter referred to as EL) elements instead of LEDs. Organic EL elements can be formed over a broad area with high density. Thus, for manufacturing the print heads including organic EL elements, a step of arranging chips with high accuracy of position is unnecessary. Therefore, the print heads including organic EL elements can be manufactured at low cost without a sophisticated mounting technique.

In general, organic EL elements are formed on a glass substrate. In this case, metal wires are generally formed on the glass substrate, too. In the case of a print head, the organic EL elements are required to emit light at a higher luminance as compared with the case of a display. However, the metal wires formed on the glass substrate have relatively high resistances. Thus, in the print head including the organic EL elements, a voltage drop is serious. Moreover, thin-film transistors formed on a glass substrate are lower in performance than transistors formed on a crystalline silicon substrate. For these reasons, the print heads including organic EL elements have drawbacks that operating speeds of circuits are insufficient, a high printing speed cannot be achieved, miniaturization is difficult, etc.

### BRIEF DESCRIPTION OF THE DRAWINGS

FIG. 1 is a plan view schematically showing a print head according a first embodiment;

FIG. 2 is a cross-sectional view of the print head shown in FIG. 1;

FIG. 3 is a cross-sectional view of an array substrate included in the print head of FIG. 1;

FIG. 4 is an equivalent circuit diagram of the array substrate included in the print head of FIG. 1;

FIG. 5 is a plan view schematically showing a print head according to a modified example;

FIG. 6 is a cross-sectional view of the print head shown in FIG. 5;

FIG. 7 is a plan view schematically showing a print head according a second embodiment;

FIG. 8 is a cross-sectional view of the print head shown in FIG. 7;

FIG. 9 is a cross-sectional view schematically showing a print head according to a modified example;

FIG. 10 is a cross-sectional view schematically showing a print head according to another modified example;

FIG. 11 is a plan view schematically showing a print head according a third embodiment;

FIG. 12 is a functional block diagram of the print heads according to first to third embodiments;

FIG. 13 is a plan view showing a modified example of the layout of the organic EL elements;

FIG. 14 is a plan view showing another modified example of the layout of the organic EL elements; and

FIG. 15 is a view schematically showing an example of an image-forming apparatus.

### DETAILED DESCRIPTION

In general, according to one embodiment, there is provided a print head comprising a first substrate extending in a first direction and having a main surface including first to third regions, the first region extending in the first direction, the second and third regions being arranged in a second direction crossing the first direction with the first region interposed between the second and third regions, an OLED array including first electrodes arranged above the first regions, an organic emitting layer positioned above the first electrodes, and a second electrode positioned above the organic emitting layer, a drive circuit configured to supply drive currents to the first electrodes, the drive circuit including a first circuit positioned above the third region and a second circuit positioned above the third region, and a second substrate positioned above the second electrode.

According to another embodiment, there is provided a print head comprising a first substrate, an OLED array including first electrodes arranged above the first substrate, an organic emitting layer positioned above the first electrodes, and a second electrode positioned above the organic emitting layer, a second substrate positioned above the second electrode, a sealant layer positioned between the first and second substrate and surrounding the OLED array, and a drive circuit configured to supply drive currents to the first electrodes, the drive circuit including first and second circuits positioned outside a region surrounded by the sealant layer.

According to still another embodiment, there is provided an image-forming apparatus comprising a photoconductor, the print head according to either one of the above embodiments, the print head configured to irradiating the photoconductor with light to form an electrostatic latent image on the photoconductor, a development device configured to supply a developer to the photoconductor having the electrostatic latent image thereon to form an pattern of the developer corresponding to the electrostatic latent image on the photoconductor, and a transfer device configured to transfer the pattern of the developer from the photoconductor on to a recording medium.

Embodiments will be described below with reference to the drawings. In the drawings, the same reference characters denote components having the same or similar functions and duplicates descriptions will be omitted.

As shown in FIG. 1, the print head 1 according to the first embodiment includes an array substrate 10, a counter substrate 20, and a circuit board 41.

The array substrate 10 has a shape extending in the first direction X. Here, the array substrate 10 has approximately rectangular shape. In FIG. 1, the reference characters L1 and L2 indicate the long sides of the rectangle, while the reference characters S1 and S2 indicate the short sides of the rectangle. Note that the second direction Y is the direction crossing the first direction X. Here, the second direction Y is perpendicular to the first direction. Note also that the third direction Z is perpendicular to the directions X and Y.

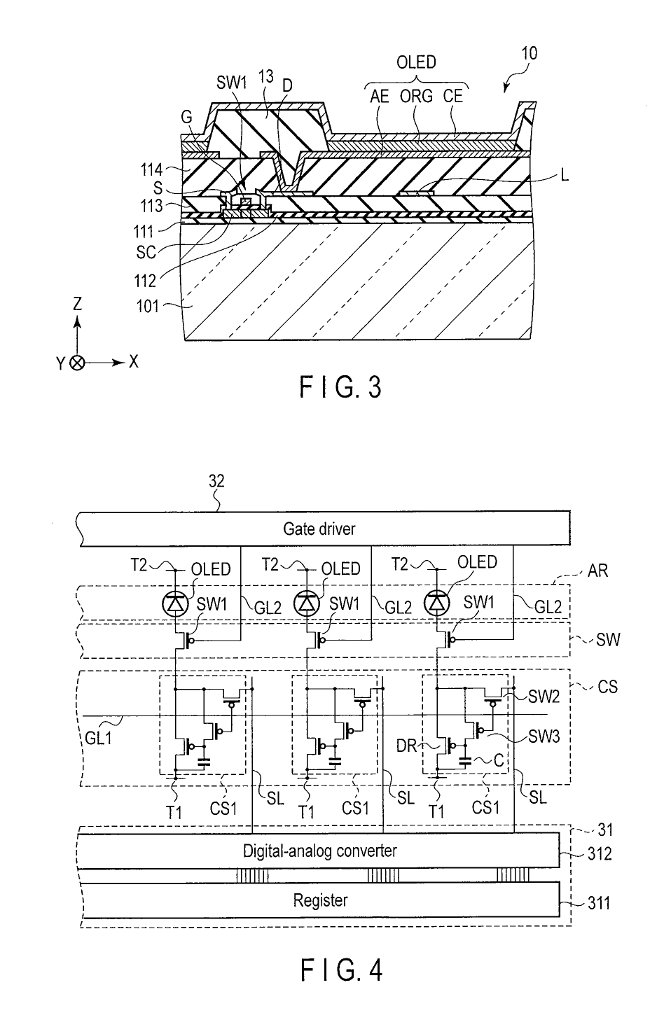

As shown in FIG. 3, the array substrate 10 includes a first substrate 101. The first substrate 101 is, for example, an insulating substrate such as glass substrate or plastic substrate. The substrate 101 may have a single layer structure or multilayer structure.

The substrate 101 has first and second main surfaces. Here, it is supposed that the first main surface includes a first region extending in the first direction X, and second and third regions arranged in the second direction Y with the first region interposed therebetween.

As shown in FIG. 4, the array substrate 10 further includes organic EL elements OLED, variable current sources CS1, switches SW1, signal lines SL, gate lines GL1 and GL2, a first circuit 31, and a second circuit 32.

As shown in FIG. 1, the organic EL elements OLED are arranged above the first region in the first direction X. As shown in FIG. 3, each organic EL element OLED includes a first electrode AE, an organic emitting layer ORG positioned above the first electrode AE, and a second electrode CE positioned above the organic emitting layer ORG. The second electrode CE is electrically connected to a power source terminal T2. Here, as an example, it is supposed that the first electrodes are anodes, while the second electrode CE is a cathode.

The variable current sources CS1 are positioned above the second region. The variable current sources CS1 are arranged correspondingly with the organic EL elements OLED to form a drive control circuit CS.

Each variable current source CS1 is configured to output a drive current at a magnitude corresponding to an image signal. In the example shown in FIG. 4, each variable current source CS1 includes a drive control element DR, switches SW2 and SW3, and a capacitor C.

The drive control element DR includes first and second terminals and a control terminal. The first terminal is electrically connected to the power supply terminal T4 and supplied with a power-supply voltage from the first power supply terminal T1. Here, it is supposed that the electric potential of the power supply terminal T1 is higher than the electric potential of the power supply terminal T2.

The drive control element DR outputs the drive current from the second terminal at a magnitude corresponding to an intensity of the signal supplied to the control terminal. That is, the second terminal is the output terminal of the variable current source CS1 or is electrically connected to the output terminal of the variable current source CS1.

In this example, the drive control element DR is a p-channel thin-film transistor (hereinafter referred to as TFT) having source and drain electrodes as the first and second terminals, respectively. The drive control element DR may have other structures. For example, the drive control element DR may include a plurality of transistors. Alternatively, an n-channel TFT may be used as the drive control element DR instead of the p-channel TFT.

The switch SW2 is electrically connected between the second terminal of the drive control element DR and the signal line SL. In this example, the switch SW2 is a p-channel TFT. The gate electrode of the switch SW2 is electrically connected to the gate line GL1. The switch SW2 may have other structures. For example, the switch SW2 may include a plurality of transistors. Alternatively, an n-channel TFT may be used as the switch SW2 instead of the p-channel TFT.

The switch SW3 is electrically connected between the control terminal and the second terminal of the drive control element DR. In this example, the switch SW3 is a p-channel TFT. The gate electrode of the switch SW3 is electrically connected to the gate line GL1. The switch SW3 may be electrically connected between the control terminal of the drive control element DR and the signal line SL. The switch SW3 may have other structures. For example, the switch SW3 may include a plurality of transistors. Alternatively, an n-channel TFT may be used as the switch SW3 instead of the p-channel TFT.

The capacitor C is electrically connected between the first power supply terminal T1 and the first terminal of the drive control element DR. The capacitor C plays a role in maintain the voltage between the first terminal and the control terminal of the drive control transistor DR constant. The capacitor C may be electrically connected between the control terminal of the drive control element DR and a constant-potential terminal other than the first power supply terminal T1. The capacitor C may be omitted.

The switches SW1 are arranged above the region correspondingly with the organic EL elements OLED to form a switching circuit SW. Each switch SW1 is electrically connected between one of the electrodes of the corresponding organic EL element OLED and the output terminal of the variable current source CS1 corresponding to this switch SW1. In this example, each switch SW1 is electrically connected between the second terminal of the drive control terminal DR shown in FIG. 4 and the first electrode AE shown in FIG. 3. Further, in this example, the switch SW1 is a p-channel TFT having a gate electrode electrically connected to the gate line GL. The switch SW1 may have other structures. For example, the switch SW1 may include a plurality of transistors. Alternatively, an n-channel TFT may be used as the switch SW1 instead of the p-channel TFT.

The signal lines SL are arranged correspondingly with the variable current sources CS1. Each signal line SL is electrically connected to the first circuit 31.

The gate line GL1 extends, for example, in the second direction Y. The gate line GL1 is electrically connected to the second circuit 32.

The gate lines GL2 are arranged correspondingly with the switches SW1. The gate lines GL2 are electrically connected to the second circuit 32.

The first circuit 31 and the second circuit 32 form the drive circuit 30 shown in FIG. 1. The drive circuit 30 controls operation of the variable current sources CS1 and the switches SW1.

The first circuit 31 is positioned above the second region. The first circuit 31 is, for example, a data driver. As shown in FIG. 4, the first circuit 31 includes a register 311 and a digital-analog converter 312.

The register 311 converts digital image signals supplied as serial data into parallel data. For example, the register 311 outputs 8 bits of image signal for each variable current source CS1.

The digital-analog converter 312 converts the image signals as digital signals supplied from the register 311 into analog signals. Specifically, the digital-analog converter 312 outputs a write signal to each signal line SL at a magnitude corresponding to the image signal.

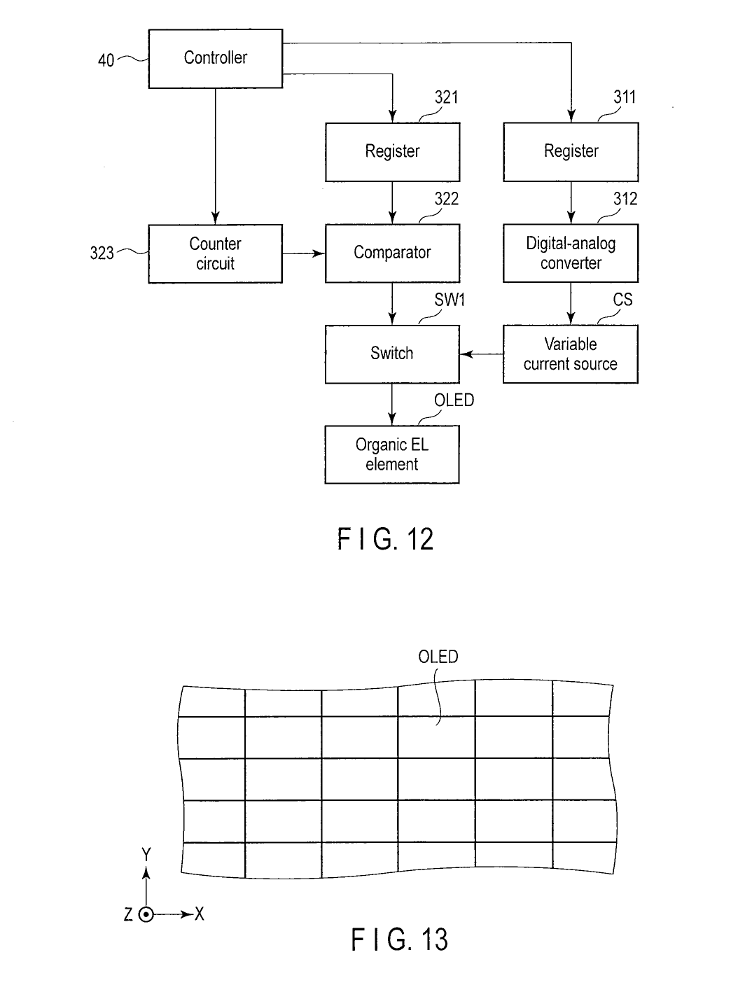

The second circuit 32 is positioned above the third region. The second circuit 32 is, for example, a gate driver. The second circuit 32 includes, for example, the register 321, the comparator 322 and the counter circuit 323 shown in FIG. 12.

The register 321 is supplied with, for example, signals corresponding to the emission durations of the organic EL elements OLED in a form of serial data. The register 321 converts the signals as the serial data into parallel data and then outputs them to the switches SW1. For example, the register 321 outputs the signal corresponding to the emission duration as 10 bits of digital signal for each of the organic EL elements OLED.

The counter circuit 323 is supplied with, for example, control signals including clock signal and start signal. The counter circuit 323 generates control signal for controlling the timing of switching between the write period and the non-write period. The second circuit 32 supplies, for example, the control signal to the gate line GL1 to control the on-off operation of switches SW2 and SW3. That is, in the write period, the second circuit 32 supplies a control signal for closing the switches SW2 and SW3 to the gate line GL1. In the non-write period, the second circuit 32 supplies a control signal for opening the switches SW2 and SW3 to the gate line GL1.

The counter circuit 323 also outputs, for example, a signal that corresponds to a time lapse after terminating the write period. Note that the write period is included in the non-write period.

The comparator 322 compares the output of the register 321 and the output of the counter circuit 323. For example, for one or more of the organic EL elements OLED that should emit light for a longer period of time, the comparator 323 supplies a control signal for closing the switch SW1 to the corresponding gate line GL2 just after terminating the write period. For one or more of the organic EL elements OLED that should emit light for a shorter period of time, the comparator 323 supplies a control signal for closing the switch SW1 to the corresponding gate line GL2 after a certain time period has elapsed from the termination of the write period.

Next, the structure of the array substrate 10 will be described.

On the first main surface of the substrate 101, the undercoat layer 111 shown in FIG. 3 is formed. The undercoat layer 111 is, for example, an insulating layer made of inorganic material such as silicon oxide or silicon nitride.

On the undercoat layer 111, the semiconductor layers SC of the transistors are arranged. Some of the semiconductor layers SC are positioned above the first region. Other semiconductor layers SC are positioned above the second region. Still other layers SC are positioned above the third region. The semiconductor layers SC are made of, for example, polysilicon. Source and drain regions are formed in each semiconductor layer SC with the channel region interposed therebetween.

The semiconductor layers SC and the undercoat layer 111 are covered with the gate insulator 112. The gate insulator 112 is made of, for example, inorganic material such as silicon oxide or silicon nitride.

On the gate insulator 112, formed is a first wiring layer including the gate electrodes G shown in FIG. 3, the gate lines GL1 and GL2 shown in FIG. 4, and the lower electrodes of the capacitors C shown in FIG. 4.

The gate electrodes G are arranged at positions corresponding to the channel regions.

The gate line GL1 is positioned, for example, above the second region and extends in the first direction X. The gate electrodes of the switches SW2 and SW3 shown in FIG. 4 are electrically connected to the gate line GL1.

Each gate line GL2 includes, for example, a portion that extends in the second direction Y from a position above the second region to a position above the third region. The gate electrodes G of the switches SW1 shown in FIGS. 3 and 4 are electrically connected to the gate lines GL2.

The lower electrodes of the capacitor C are arranged correspondingly with the drive control elements DR. The lower electrodes of the capacitor C are electrically connected to the gate electrodes G of the drive control elements DR.

The first wiring layer further includes wirings, etc. (not shown) above the second and third regions. These constitute parts of the elements or wires of the first circuit 31 and the second circuit 32.

The first wiring layer and the gate insulator 112 are covered with the first interlayer insulator 113. The first interlayer insulator 113 is made of, for example, inorganic material such as silicon oxide or silicon nitride.

On the first interlayer insulator 113, a second wiring layer including the source electrodes S, the drain electrodes D, the upper electrodes of the capacitors C, and one or more lines L.

Each source electrode S is in contact with the source region of the semiconductor layer SC. The drain electrode D is in contact with the drain region of the semiconductor layer SC.

The upper electrodes of the capacitors C face the lower electrodes of the capacitor C. Each of the upper electrodes is electrically connected to the source electrode S of the drive control element DR.

The line L extends from a position above the second region to a position above the third region. The line L electrically connecting the first circuit 31 to the second circuit 32. The line L is used, for example, for supplying electric power from one of the circuits 31 and 32 to the other of the circuits 31 and 32.

The second wiring layer is made of, for example, an electrically conducting material such as molybdenum, tungsten, aluminum or titanium. The gate electrodes G, the source electrodes S and the drain electrodes D may have a multilayer structure including conductive layer stacked one on top of the other.

The source electrodes S, the drain electrodes D and the first interlayer insulator 113 are covered with the second interlayer insulator 114. The second interlayer insulator 114 is made from, for example, organic material such as ultraviolet curable resin or thermosetting resin. As the material of the second interlayer insulator 114, inorganic material such as silicon nitride may be used.

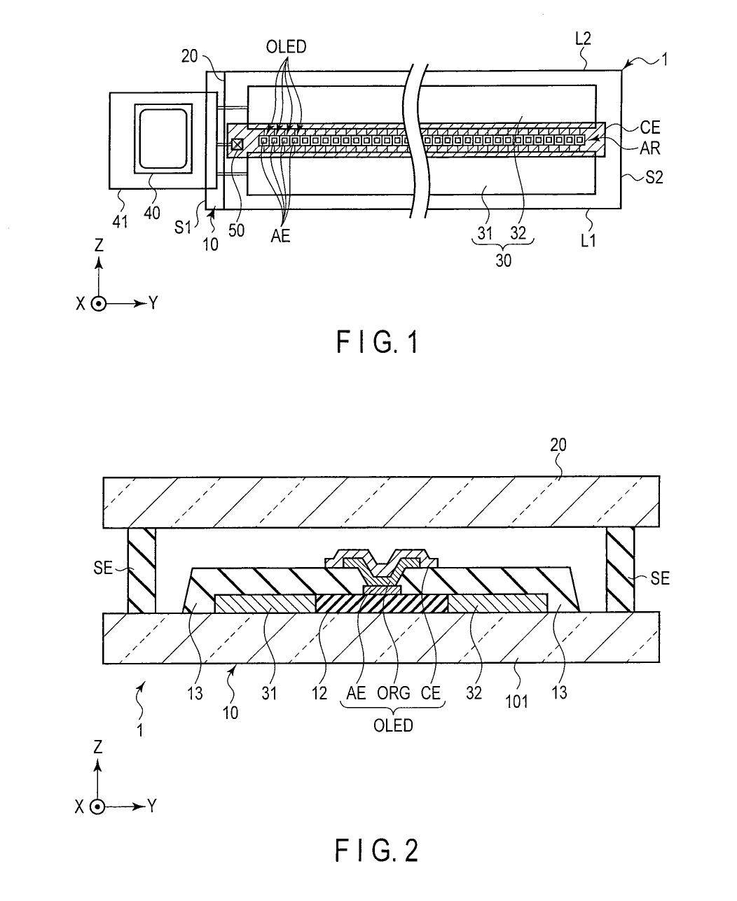

Contact holes are formed in the second interlayer insulator 114 at positions of the switches SW1. Specifically, each contact hole communicate with the drain electrode D of the switch SW1. Note that the insulating layer shown in FIG. 2 is a layer including the interlayer insulators 113 and 114.

The organic EL elements OLED are arranged on the second interlayer insulator 114. As shown in FIG. 1, the organic EL elements OLED are arranged in the first direction X to form a linear array AR.

Each of the organic EL elements OLED includes the first electrode AE, the organic emitting layer ORG and the second electrode CE.

The first electrodes AE are arranged on the second interlayer insulator 114. Each electrode AE include an electrode body and a contact portion. The contact portion extend in the contact hole of the second interlayer insulator 114 and electrically connecting the electrode body to the drain electrode D of the switch SW1. The electrodes AE are, for example, anodes. The electrodes AE are spaced apart from one another.

Various structures may be employed in the first electrodes AE. In the example shown in the drawings, each of the electrodes AE has a two-layer structure including a light-reflecting layer and a light-transmitting layer. The light-reflecting layers are arranged on the interlayer insulator 114. The light-transmitting layers are arranged on the light-reflecting layers, respectively. The light-reflecting layers are made of, for example, an electrically conducting material having a light-reflecting property such as silver or aluminum. The light-transmitting layer is made of, for example, an electrically conducting material having a light-transmitting property such as indium tin oxide or indium zinc oxide.

The electrodes AE may be a light-reflecting or transmitting layer having a single layer structure. Alternatively, The electrodes AE have a multilayer structure including three or more layers. In the case where this device is of a top emission type, the electrodes AE include at least the light-reflecting layers. In the case where this device is of a bottom emission type, the electrodes AE do not include the light-reflecting layers.

On the second interlayer insulator 114, the insulating layer 13 is further provided. The insulating layer 13 covers the second interlayer insulator 114 and the peripheries of the electrodes AE. The insulating layer 13 is made from, for example, organic material such as ultraviolet curable resin or thermosetting resin.

The organic emitting layer ORG is formed above the first electrodes AE. The organic emitting layer ORG covers the first electrodes AE and the portions of the insulating layer 13 adjacent to the first electrodes AE. The material of the organic emitting layer ORG may be a fluorescence material or a phosphorescence material.

The second electrode CE is formed above the organic emitting layer ORG. In this example, the electrode CE is a cathode.

The second electrode CE is a common electrode. Each variable current source CS1 is positioned at least partially below the electrode CE.

The second electrode CE is, for example, a semitransparent layer. The semitransparent layer is made of, for example, an electrically conducting material such as magnesium or silver. The electrode CE may have a two-layer structure including the semitransparent layer and a transparent layer or a single-layer structure of a transparent or semitransparent layer. The transparent layer is made of, for example, an electrically conducting material having a light-transmitting property such as indium tin oxide or indium zinc oxide. In the case where this device is of a bottom emission type, the electrode CE includes a light-reflecting layer or the semitransparent layer.

Each of the organic EL element OLED may further include one or more layers such as hole injection layer, hole-transporting layer, electron-transporting layer and electron injection layer.

The counter substrate 20 is the second substrate positioned above the organic EL elements OLED. As the counter substrate 20, for example, an insulating substrate having a light-transmitting property such as glass substrate or plastic substrate can be used.

The sealant layer SE extend along the periphery of counter substrate 20 between the array substrate 10 and the counter substrate 20. The sealant layer SE is made from, for example, adhesive.

The circuit board 41 has the controlling integrated circuit (hereinafter referred to as IC) 40 as a controller mounted thereon. The controlling IC 40 is electrically connected to the first circuit 31 and the second circuit 32 via wirings on the circuit board 41 so as to supply the circuits 31 and 32 with signals for their operation. The controlling IC 40 is also electrically connected to the feeding point 50 on the array substrate 10. The second electrode CE is in contact with the feeding point 50.

The print head 1 may includes two or more circuit boards 41. In the case where the print head 1 includes two circuit boards 41, it is possible that one of the circuit boards 41 is bonded to the array substrate 10 at the position of the short side S1, while the other of the circuit boards 41 is bonded to the array substrate 10 at the position of the short side S2.

Typically, the print head 1 further includes a lens array or an optical system that includes the lens array. In this case, the print head 1 and the lens array or the optical system are arranged such that the lens array or the optical head guides the light emitted from the substrate 20 of the print head 1 onto the photoconductor of the image-forming apparatus to be described later.

The print head 1 achieves high performance as will be described below.

In general, the operating frequency of the variable current sources CS1 is lower than the operating frequency of a digital circuit, for example, the register 321 or the comparator 322. Thus, the operation of the variable current sources CS1 are prone to be affected by the noise originated from the digital circuit.

In this print head 1, each variable current source CS1 is interposed at least partially between one of the main surfaces of the substrate 101 and the second electrode CE. Thus, a parasitic capacitance is produced between each variable current source CS1 and the second electrode CE. As a result, the operation of the variable current sources CS1 becomes less prone to be affected by the noise originated from the digital circuit. Note that the variable current sources CS1 cause almost no performance deterioration due to the parasitic capacitance because they do not require high speed operation in contrast to the digital circuit.

It is possible that the second electrode CE does not include a portion positioned above the digital circuit, for example, one or more of the register 321, the comparator 322, the digital-analog converter 312 and the register 311. For example, the second electrode CE may include no portion above the first circuit 31. Alternatively, the second electrode CE may include no portion above the second circuit 32. Alternatively, the second electrode CE may include no portion above the first circuit 31 and the second circuit 32. In the case where such a structure is employed, the operation of the variable current sources CS1 are prone to be affected by the noise originated from the digital circuit as compared with the case where a part of the second is positioned above the digital circuit.

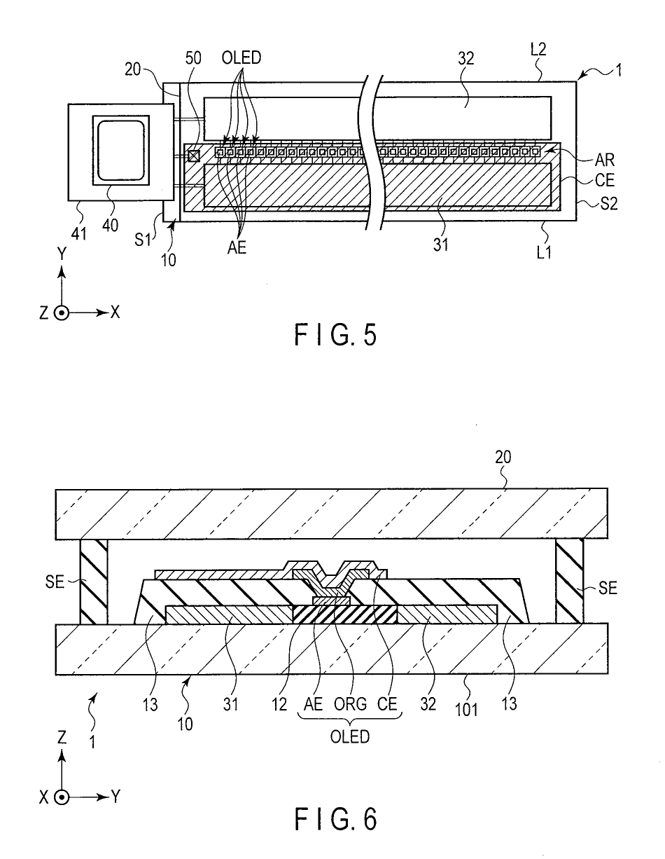

In the example shown in FIGS. 5 and 6, the second electrode CE includes a portion positioned above the variable current sources CS1, the switches SW1 and the first circuit 31. In the case of employing such a structure, the operation of the variable current sources CS1 are less prone to be affected by the noise originated from the digital circuit as compared with the case where a portion of the second electrode CE is positioned above the digital circuit.

In the structure shown in FIGS. 5 and 6, the dimension of the second electrode CE in the second direction Y is larger than that in the structure described with reference to FIGS. 1 and 2. Thus, in the structure shown in FIGS. 5 and 6, the voltage drop due to the sheet resistance of the second electrode CE is suppressed than that in the structure described with reference to FIGS. 1 and 2.

Various modifications can be made to the layout of the circuits. For example, the switches SW1 may be arranged above the first region. Alternatively, the switches SW1 and the variable current sources CS1 may be arranged above the first region.

In the structure described with reference to FIGS. 1 and 2, the switching circuit SW, the drive control circuit CS, the first circuit 31 and the second circuit 32 are arranged in the region sandwiched between the substrates 102 and 20 and surrounded by the sealant layer SE. One or more of the switching circuit SW, the drive control circuit CS, the first circuit 31 and the second circuit 32 may be arranged outside the above region.

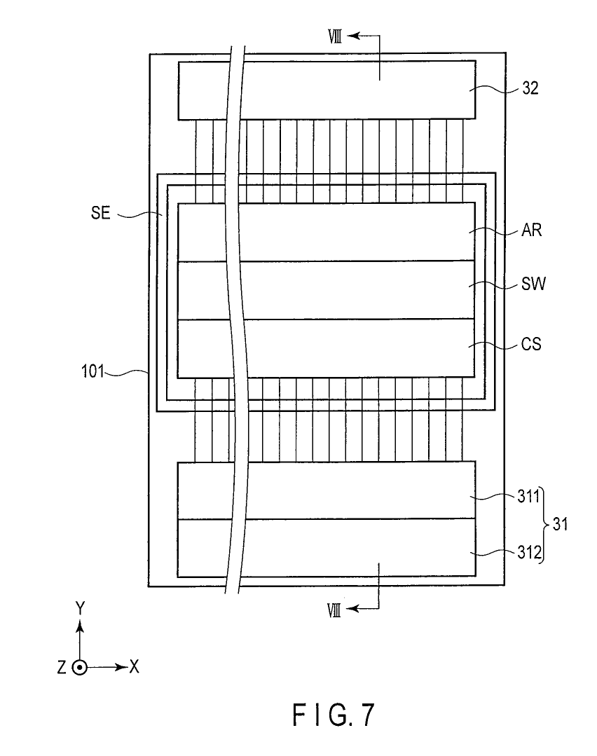

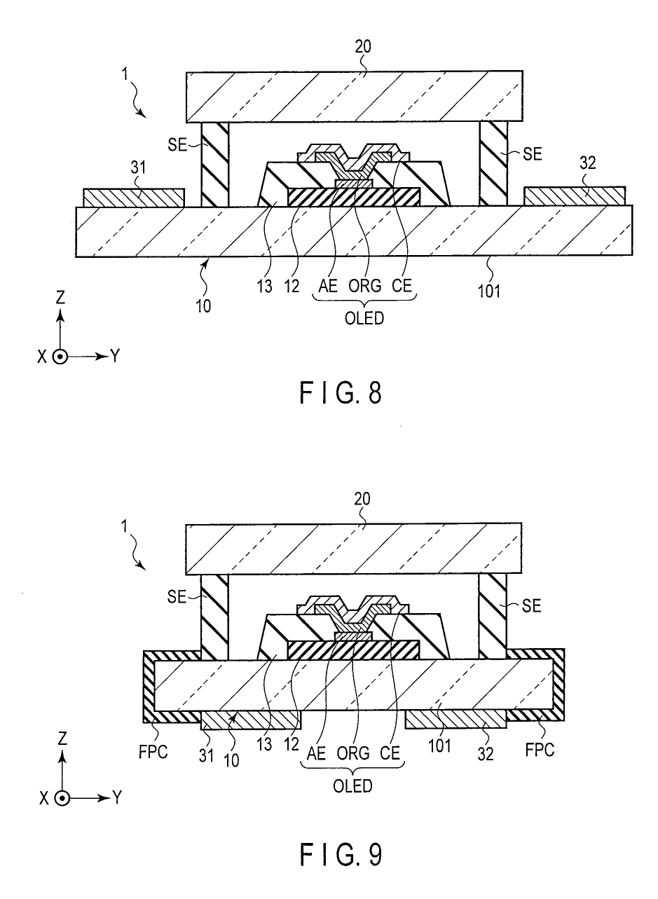

As shown in FIGS. 7 and 8, in the print head 1 according to the second embodiment, the switching circuit SW and the drive control circuit CS are positioned in the region sandwiched between the substrates 101 and 20 and surrounded by the sealant layer SE. On the other hand, the first circuit 31 and the second circuit 32 are positioned outside the region sandwiched between the substrates 101 and 20 and surrounded by the sealant layer SE. As above, one or more of the circuits 31 and 32 may be arranged outside the region sandwiched between the substrates 101 and 20 and surrounded by the sealant layer SE.

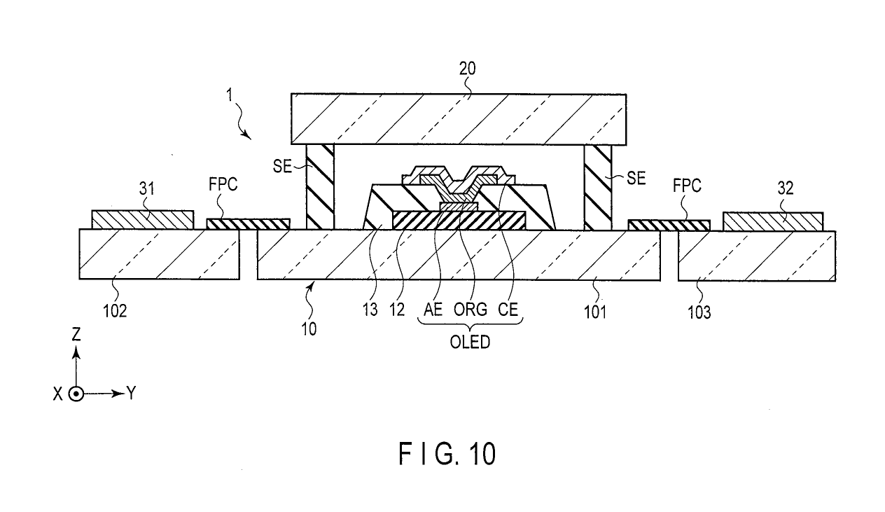

In the case where, the first circuit 31 and the second circuit 32 are arranged outside the above region, it is possible that the first circuit 31 and the second circuit 32 are arranged on the backside of the array substrate 10 and the circuits 31 and 32 are electrically connected to the drive control circuit CS and the switching circuit SW via the flexible printed circuit boards FPC as shown in FIG. 9. Alternatively, as shown in FIG. 10, it is possible that the first circuit 31 and the second circuit 32 are arranged on the substrates 31 and 32, respectively, and the circuits 31 and 32 are electrically connected to the drive control circuit CS and the switching circuit SW via the flexible printed circuit boards FPC.

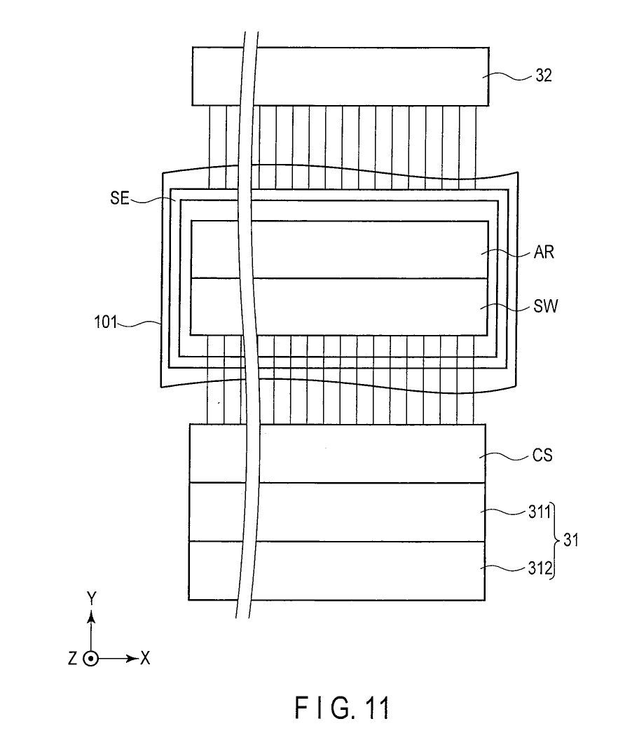

As shown in FIG. 11, in the print head 1 according to the third embodiment, the switching circuit SW is positioned in the region sandwiched between the substrates 101 and 20 and surrounded by the sealant layer SE. On the other hand, the drive control circuit CS, the first circuit 31 and the second circuit 32 are placed outside the region sandwiched between the substrates 101 and 20 and surrounded by the sealant layer SE. As above, the drive control circuit CS may be located outside the region sandwiched between the substrates 101 and 20 and surrounded by the sealant layer SE.

The switching circuit SW may be placed outside the region sandwiched between the substrates 101 and 20 and surrounded by the sealant layer SE. For example, the switching circuit SW, the drive control circuit CS, the first circuit 31 and the second circuit 32 may be arranged outside the above region.

At least one of the circuits 31 and 32 or a part thereof may be in a form a semiconductor chip mounted on the array substrate 10 or a semiconductor chip mounted on a flexible printed circuit board connected to the array substrate 10. For example, it is possible that the variable current sources CS1 the switches SW1 are formed above the substrate 101, one or more of the register 311, the digital-analog converter 312, the register 321 and the comparator 322 is/or in a form a semiconductor chip mounted on the array substrate 10 or a semiconductor chip mounted on a flexible printed circuit board connected to the array substrate 10, and, if any, the remainder of the register 311, the digital-analog converter 312, the register 321 and the comparator 322 is/or formed above the substrate 101.

Various modifications can also be made to the layout of the organic EL elements OLED.

In FIG. 13, the organic EL elements OLED form rows each extending in the first direction X and arranged in the second direction Y. In other words, the organic EL elements OLED are arranged in the first direction X and the second direction Y.

In the case of employing such a structure, it is possible, for example, to irradiate certain areas on the photoconductor with light using the organic EL elements OLED in the first row, and then irradiate the above areas with light using the organic EL elements OLED in the second row. This makes it possible to achieve a sufficient exposure value while driving each organic EL element OLED to emit light at a low luminance. Therefore, in this case, the degradation of the organic EL elements is less prone to occur as compared with the case where the organic EL elements OLED are arranged in a line.

Further, in the case of employing the above-described structure, it is possible, for example, to use the organic EL elements OLED in the second row instead of the organic EL elements OLED in the first row when the organic EL elements OLED in the first row are degraded. In this case, the print head 1 can be used for a longer period of time as compared with the case where the organic EL elements OLED are arranged in a line.

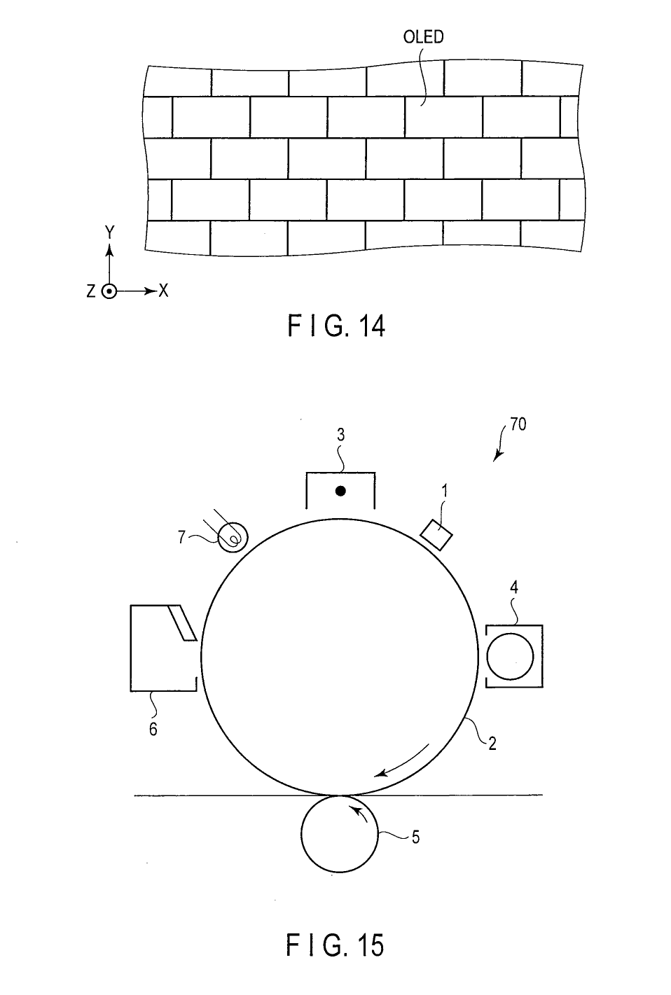

The structure shown in FIG. 14 is the same as that described with reference to FIG. 13 except that the organic EL elements OLED are arranged in the first direction X and a direction inclined with respect to the first direction X. In the case of employing this structure, the same effects as those described with reference to FIG. 13 can be obtained. In addition, in the case of employing this structure, the arrangement of the wires can be designed easily as compared with the case of employing the structure described with reference to FIG. 13.

Next, an image-forming apparatus including the print head 1 will be described. Although, described below is a dry-type image-forming apparatus that uses a powder developer, the above-described print head 1 can be incorporated in a wet-type image-forming apparatus that uses a liquid developer.

The image-forming apparatus 70 shown in FIG. 15 is, for example, an electrophotographic apparatus. The image-forming apparatus 70 may be an electrostatic printer.

The image-forming apparatus 70 includes the print head 1, a photoconductor 2, a charger 3, a developing device 4, a transfer device 5, a cleaner 6 and a neutralizer 7. The charger 3, the print head 1, the developing device 4, the transfer device 5, the cleaner 6 and the neutralizer 7 are arranged in a clockwise direction around the photoconductor 2 in this order.

The photoconductor 2 includes a substrate having an electrically conductive surface and a photoconductive layer formed on the electrically conductive surface. The surface of the photoconductive layer an image-bearing surface. The photoconductor layer includes, for example, an organic, amorphous silicon, SeTe or zinc oxide-based photosensitive material that changes its charged state by light irradiation.

Here, the photoconductor 2 is a photoconductor drum. The photoconductor 2 may have other structures. For example, the photoconductor 2 may be in the form of a belt. The photoconductor 2 rotates in a clockwise direction by the action of a drive mechanism (not shown).

The charger 3 is placed to face the image-bearing surface of the photoconductor 2. The charger 3 is, for example, a corona charger represented by the corotoron charger and the scorotoron charger. The charge 3 charges the photoconductive layer in a positive or negative polarity.

The print head 1 is placed, for example, such that the first direction X is parallel with the image-bearing surface of the photoconductor 2 and perpendicular to the moving direction of the image-bearing surface. Typically, the print head 1 is placed near the image-bearing surface of the photoconductor 2.

The print head 1 allows the image-bearing surface of the photoconductor 2 to be irradiated with the light emitted by the organic EL elements OLED in a pattern corresponding to the image to be formed. As a result of the light irradiation, a difference in surface potential is caused between the irradiated and non-irradiated portions. That is, an electrostatic latent image is formed on the image-bearing surface.

The developing device 4 is placed to face the image-bearing surface of the photoconductor 2. The developing device supplies the image-bearing surface with an electrically charged developer, a toner herein, so as to form a developer image. The formation of the developer image can be performed using the charged area development process or the discharged area development process.

The transfer device 5 is a transfer roller in this example. The transfer roller faces image-bearing surface of the photoconductor 2 with the recording medium 8 such as a paper interposed therebetween such that its rotation axis is parallel with the rotation axis of the photoconductor 2. The transfer roller rotates in the counterclockwise direction by the action of the drive mechanism (not shown).

The transfer roller includes, for example, a heater. In this case, the transfer device 5 transfers the developer image from the image-bearing surface of the photoconductor onto the recording medium 8 utilizing heat and pressure. For transferring the developer image, an electrostatic force may be utilized. For example, a voltage with a polarity opposite to the polarity of the developer image may be applied to the transfer roller. In this case, the pattern of the developer can be transferred from the image-bearing surface of the photoconductor onto the recording medium 8, too.

Although FIG. 13 shows the transfer roller as the transfer device 5, the transfer device 5 can have other structures. For example, the transfer device 5 may further include an intermediate transfer roller. Alternatively, the transfer device 5 may include a transfer belt and supporting rolls.

The cleaner 6 is placed to face the image-bearing surface of the photoconductor 2. The cleaner 6 cleans the image-bearing surface.

The neutralizer 7 is placed to face the image-bearing surface of the photoconductor 2. The neutralizer 7 electrically neutralizes the image-bearing surface by, for example, light irradiation.

As described above, in the print head 1, the operation of the variable current sources CS1 are less prone to be affected by the noise originated from the digital circuit. Thus, the print head 1 can operate stably. To be more specific, the degree of correlation between the luminance signal and the actual luminance is high. Therefore, this image-forming apparatus 70 is excellent in reproducibility of image density.

Although described herein is a monochrome image-forming apparatus, the print head 1 can also be used in a color image-forming apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A print head comprising:
a first substrate extending in a first direction and having a main surface including first to third regions, the first region extending in the first direction, the second and third regions being arranged in a second direction crossing the first direction with the first region interposed between the second and third regions;
an OLED array including first electrodes arranged above the first regions, an organic emitting layer positioned above the first electrodes, and a second electrode positioned above the organic emitting layer;
a drive circuit configured to supply drive currents to the first electrodes, the drive circuit including a first circuit positioned above the third region and a second circuit positioned above the third region; and
a second substrate positioned above the second electrode.

2. The print head according to claim 1, wherein the first circuit is configured to output an analog signal, and the second circuit is configured to output a digital signal.

3. The print head according to claim 1, wherein the first circuit is configured to be operated at an operating frequency lower than an operating frequency for the second circuit.

4. The print head according to claim 1, wherein the drive circuit further includes variable current sources arranged correspondingly with the first electrodes and each configured to output the drive current at a magnitude corresponding an image signal, and the first circuit includes digital-analog converters each configured to convert the image signal as a digital signal into analog signal and supply the analog signal to one of the variable current sources.

5. The print head according to claim 1, wherein the drive circuit further includes variable current sources arranged correspondingly with the first electrodes and each configured to output the drive current at a magnitude corresponding an image signal, and the first circuit further includes registers each configured to store information corresponding to characteristics of the variable current source, correct the image signal as a digital signal based on the information, and supply the corrected image signal to the digital-analog converter.

6. The print head according to claim 1, further comprising an insulating layer interposed between the first substrate and the first electrodes,
wherein the drive circuit further includes variable current sources arranged correspondingly with the first electrodes and each configured to output the drive current at a magnitude corresponding an image signal, and one or more lines extending between the first region and the insulating layer from a position corresponding to the second region to a position corresponding to the third region, each of the lines electrically connecting the first circuit to the second circuit, and
wherein each of the output control switches includes a thin-film transistor.

7. The print head according to claim 1, wherein the first electrodes form rows each extending in the first direction and arranged in a third direction crossing the first direction.

8. The print head according to claim 1, wherein the second electrode extends above the first circuit.

9. A print head comprising:
a first substrate;
an OLED array including first electrodes arranged above the first substrate, an organic emitting layer positioned above the first electrodes, and a second electrode positioned above the organic emitting layer;
a second substrate positioned above the second electrode;
a sealant layer positioned between the first and second substrate and surrounding the OLED array; and
a drive circuit configured to supply drive currents to the first electrodes, the drive circuit including first and second circuits positioned outside a region surrounded by the sealant layer.

10. An image-forming apparatus comprising:
a photoconductor;
a print head configured to irradiating the photoconductor with light to form an electrostatic latent image on the photoconductor, the print head comprising
a first substrate extending in a first direction and having a main surface including first to third regions, the first region extending in the first direction, the second and third regions being arranged in a second direction crossing the first direction with the first region interposed between the second and third regions,
an OLED array including first electrodes arranged above the first regions, an organic emitting layer positioned above the first electrodes, and a second electrode positioned above the organic emitting layer,
a drive circuit configured to supply drive currents to the first electrodes, the drive circuit including a first circuit positioned above the third region and a second circuit positioned above the third region, and
a second substrate positioned above the second electrode;
a development device configured to supply a developer to the photoconductor having the electrostatic latent image thereon to form an pattern of the developer corresponding to the electrostatic latent image on the photoconductor; and
a transfer device configured to transfer the pattern of the developer from the photoconductor on to a recording medium.

11. The image-forming apparatus according to claim 10, wherein the first circuit is configured to output an analog signal, and the second circuit is configured to output a digital signal.

12. The image-forming apparatus according to claim 10, wherein the first circuit is configured to be operated at an operating frequency lower than an operating frequency for the second circuit.

13. The image-forming apparatus according to claim 10, wherein the drive circuit further includes variable current sources arranged correspondingly with the first electrodes and each configured to output the drive current at a magnitude corresponding an image signal, and the first circuit includes digital-analog converters each configured to convert the image signal as a digital signal into analog signal and supply the analog signal to one of the variable current sources.

14. The image-forming apparatus according to claim 10, wherein the drive circuit further includes variable current sources arranged correspondingly with the first electrodes and each configured to output the drive current at a magnitude corresponding an image signal, and the first circuit further includes registers each configured to store information corresponding to characteristics of the variable current source, correct the image signal as a digital signal based on the information, and supply the corrected image signal to the digital-analog converter.

15. The image-forming apparatus according to claim 10, further comprising an insulating layer interposed between the first substrate and the first electrodes,
wherein the drive circuit further includes variable current sources arranged correspondingly with the first electrodes and each configured to output the drive current at a magnitude corresponding an image signal, and one or more lines extending between the first region and the insulating layer from a position corresponding to the second region to a position corresponding to the third region, each of the lines electrically connecting the first circuit to the second circuit, and
wherein each of the output control switches includes a thin-film transistor.

16. The image-forming apparatus according to claim 10, wherein the first electrodes form rows each extending in the first direction and arranged in a third direction crossing the first direction.

17. The image-forming apparatus according to claim 10, wherein the second electrode extends above the first circuit.

18. An image-forming apparatus comprising:
a photoconductor;
a print head configured to irradiating the photoconductor with light to form an electrostatic latent image on the photoconductor, the print head comprising
a first substrate,
an OLED array including first electrodes arranged above the first substrate, an organic emitting layer positioned above the first electrodes, and a second electrode positioned above the organic emitting layer;
a second substrate positioned above the second electrode,
a sealant layer positioned between the first and second substrate and surrounding the OLED array, and
a drive circuit configured to supply drive currents to the first electrodes, the drive circuit including first and second circuits positioned outside a region surrounded by the sealant layer;
a development device configured to supply a developer to the photoconductor having the electrostatic latent image thereon to form an pattern of the developer corresponding to the electrostatic latent image on the photoconductor; and
a transfer device configured to transfer the pattern of the developer from the photoconductor on to a recording medium.
